(19) United States
(12) Patent Application Publication
(10) Pub. No.: US 2004/0176493 A1
(43) Pub. Date: Sep. 9, 2004

(54) Silicone foam

(76) Inventor: Terrell W. Ferguson, Georgetown, KY (US)

Correspondence Address: KING & SCHICKLI, PLLC, 247 NORTH BROADWAY, LEXINGTON, KY, 40507, US

(21) Appl. No.: 10/480,401

(22) PCT Filed: Aug. 23, 2002
(86) PCT No.: PCT/US02/27071

Related U.S. Application Data
(60) Provisional application No. 60/344,164, filed on Dec. 27, 2001.
(60) Provisional application No. 60/314,988, filed on Aug. 24, 2001.

(51) Int. Cl. C08J 9/00

(52) U.S. Cl. 521/154

(57) ABSTRACT

A foam material is provided that is formed from a body of silicone having a cellular structure formed by a plurality of interconnected voids. The voids have a relatively high volume of between about 0.06545 to about 268.0832 mm³ and more typically about 65.45 to about 179.5948 mm³. The foam material displays unique tactile properties.

This patent application claims the benefit of U.S. Provisional Patent Applications Serial No. 60/344,164 filed on Dec. 27, 2001 and 60/314,988 filed on Aug. 24, 2001.

### TECHNICAL FIELD

The present invention relates generally to the manufacture of silicone foam useful for a number of product applications.

### BACKGROUND OF THE INVENTION

Silicone foams are well known in the art. Silicone foams exhibit a number of favorable properties which support their use for a wide variety of applications. These applications include but are not limited to use (a) in the construction of medical prosthetic devices, (b) as a cushion or filler in the bedding, furniture, automotive and marine industries, as well as (c) for helmet and equipment padding. The advantageous properties of silicone foam that have been found to be particularly beneficial include good UV resistance, resistance to salt water, relative physiological harmlessness, freedom from odor, chemical resistance, resistance to aging and low combustibility. When silicone foams are used in medical prostheses, additional beneficial characteristics include breatheability or gas permeability and relatively high wearer comfort.

The present invention relates to a novel silicone foam having a consistent cellular structure which produces a unique combination of tactile characteristics which make the foam particularly suited for use in the production of medical prostheses.

### SUMMARY OF THE INVENTION

The advantages and other novel features of the invention will be set forth in part in the description that follows and in part will become apparent to those skilled in the art upon examination of the following or may be learned with the practice of the invention. The objects and advantages of the invention may be realized and obtained by means of the instrumentalities and combinations particularly pointed out in the appended claims.

In accordance with the purposes of the present invention as described herein, an improved foam material is provided. That foam material may be broadly defined as comprising a body of silicone having a consistent cellular structure formed by a plurality of interconnected voids.

The foam material includes a density of between about 5.0 to about 10.0 lbs/ft³. Further, the foam material is characterized by a compression deflection at 25 percent psi of about 0.5 to about 1.0 and at 50 percent psi of about 0.5 to about 3.0. The foam material also includes a specific gravity of about 0.1 to about 0.15.

In accordance with yet another aspect of the present invention, the body comprises from about 25 to about 41 and more particularly about 33 percent by volume silicone and from about 75 to about 59 and more particularly about 67 percent by volume void space. Each void of the plurality of the interconnected voids has a volume of between about 0.06545 to about 268.0832 mm³ and more typically of between about 65.45 to about 179.5948 mm³.

In the following description there is shown and described a preferred embodiment of the present invention simply by way of illustration of one of the modes best suited to carry out the invention. As it will be realized, the invention is capable of other different embodiment and its several details are capable of modification in various, obvious aspects all without departing from the invention. Accordingly, the drawings and descriptions will be regarded as illustrative in nature and not as restrictive.

### BRIEF DESCRIPTION OF THE DRAWING

The accompanying drawing incorporated in and forming a part of this specification, illustrates several aspects of the present invention, and together with the description serves to explain the principles of the invention. In the drawing:

FIG. 1 is a perspective view of a cubic piece of silicone foam of the present invention illustrating the consistent cellular structure of that foam formed by the plurality of interconnected voids.

Reference will now be made in detail to the preferred embodiment of the present invention, an example of which is illustrated in the accompanying drawing.

### DETAILED DESCRIPTION OF THE INVENTION

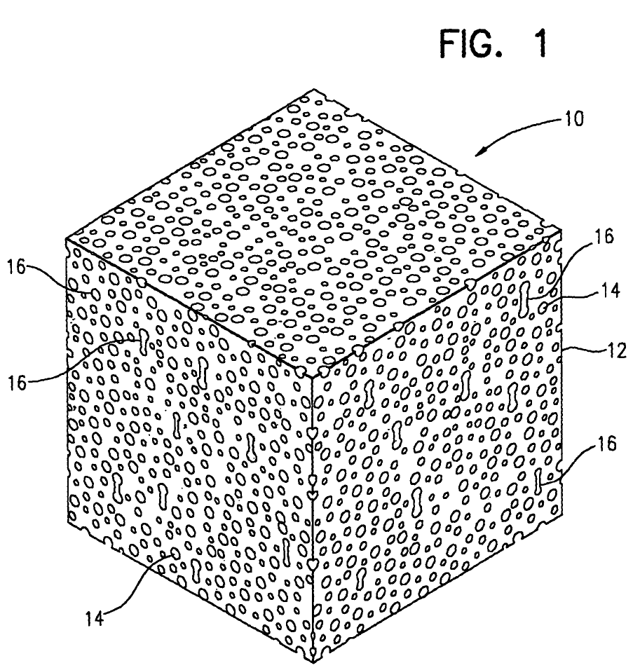

Reference is now made to FIG. 1 showing a cubic piece of the silicone foam material 10 of the present invention. As shown, the silicone foam material 10 comprises a body 12 of silicone having a consistent cellular structure formed by a plurality of interconnected voids 14.

More specifically, the body 12 of foam material 10 comprises from about 25 to about 41 percent by volume and more typically about 33 percent by volume silicone and from about 75 to about 59 and more typically about 67 percent by volume void space. Further, each void of the plurality of interconnected voids has a volume of between about 0.06545 to about 268.0832 mm³. Still more typically, each of the plurality of inter-connected voids has a volume of between about 65.45 to about 179.5948 mm³. As a result, the body 12 of foam material has a density of between about 5.0 to about 10.0 lbs/ft³.

The foam material 10 may also be characterized by other physical characteristics including a compression deflection at 25 percent psi of about 0.5 to about 1.0 and at 50 percent psi of about 0.5 to about 3.0. Additionally, the body 12 of foam material 10 includes a specific gravity of about 0.1 to about 0.15.

In accordance with an important aspect of the present invention, it should be appreciated that the body 12 of foam material includes a consistent cellular structure. This is made possible by purposely providing all voids in the cellular body with a volume of at least 0.06545 to about 268.0832 mm³. When the foam material 10 of the present invention is to be used in the construction of a medical prosthesis, each void is more typically formed to have a volume of about 65.45 to about 179.5948 mm³. These voids of relatively large volume provide the silicone foam 10 of the present invention with a unique texture and tactile sensation that more closely mimics the flesh and body of the living organism and, therefore, the present invention represents a very significant advance in the art.

It should be appreciated that it is not possible to consistently produce voids of the relatively high volume found in the present silicone foam material 10 by means of a chemical foaming agent. Specifically, there is simply no known way in the art to effectively control the formation and distribution of the gas generated in the silicone foam during the gas foaming process to produce the desired consistent cellular structure assumed by the plurality of relatively high volume voids 14. Stated another way, chemical foaming agents form voids of varying size without any effective means of controlling void formation. Instead, the present silicone foam material 10 is formed by using a mechanical foaming agent.

More specifically, the method of production of the silicone foam material 10 of the present invention may be generally described as including the steps of adding a mechanical foaming agent to uncured silicone, curing the silicone and removing the mechanical foaming agent from the silicone thereby providing the silicone foam material. In accordance with the most preferred embodiment of the invention, the mechanical foaming agent utilized in the production of the present silicone foam material 10 is a plurality of solid bodies that are insoluble in the silicone. Any appropriate solid material may be utilized for the intended purpose including but not limited to material selected from a group consisting of metal, plastic, glass, cured silicone beads and mixtures thereof.

The bodies may comprise substantially any shape, regular or irregular, spherical, cylindrical, teardrop, pellet, bead, particulate, etc. The solid bodies of mechanical foaming agent typically have a width/diameter of between about 0.5 to about 8.0 mm. Solid bodies utilized in the production of the silicone foam material 10 to be utilized in the production of medical prostheses typically have a width/diameter of between about 5.0 to about 7.0 mm. Each solid body utilized has a volume of between about 0.06545 to about 268.0832 mm³ and more typically from 65.45 to about 179.5948 mm³. Of course, the quantity, size and shape of the bodies of mechanical foaming agent may be varied to produce a silicone foam with differing physical properties such as density and resiliency. For example, by increasing the size of the mechanical foaming agent bodies used in the process, the resulting silicone foam is made less resistant to linear deformation, i.e. flex increases. The density of the foam may be increased by the use of smaller more tightly packed bodies. A very soft foam may be made using bodies having a width/diameter of about 1 mm. The addition of silicone oil to silicone (up to about 40 percent by weight) increases the softness of the product. Thus, it should be appreciated that the silicone foam may be tailored to provide appropriate properties for any particular application.

The silicone foam material 10 of the present invention may be formed in substantially any desired shape by using an appropriately shaped mandrel and/or mold. Specifically, an appropriate amount of silicone for the product being molded is mixed with an appropriate amount of polymerization catalyst (e.g. in a 10:1 ratio) and the appropriate quantity, size and shape of mechanical foaming agent is added (e.g. the mechanical foaming agent is added in substantially any amount but typically between about 75 to about 59 percent by volume). A ratio of 1 part by volume foam to 2 parts by volume mechanical foaming agent has been found to be particularly useful in the production of medical prostheses. The silicone, polymerization catalyst and mechanical foaming agent mixture is mixed and then injected, poured or otherwise introduced into the mold. The material is then allowed to cure.

Following curing, the molded silicone foam material 10 is removed from the mold and then the mechanical foaming agent is removed from the silicone foam material. Substantially any method of removal may be utilized so long as the desired integrity and physical characteristics of the silicone foam material are maintained following removal. Thus, it should be appreciated that the solid bodies of mechanical foaming agent may be removed from the silicone foam material by pressing, vacuuming or even magnetic attraction where magnetic mechanical foaming agents such as iron balls are utilized. For certain applications, it may be desired to lubricate the mechanical foaming agent prior to removal by introducing water and soap into the silicone foam material. The water and soap may, of course, be easily removed and dried from the final silicone foam material product.

It should be realized that the solid bodies of mechanical foaming agent deep within the molded product must pass through the body of the product during removal. Specifically, the bodies follow a path of least resistance and pass from void to void by forming channels or pathways 16 that interconnect the voids thereby making a singularly unique structure with singularly unique tactile characteristics. Those characteristics have been found to more closely resemble or mimic the tactile properties of live tissue than any silicone or other polymer based prosthesis heretofore available in the art.

Of course, it should be appreciated that the mechanical foaming agent removed from the silicone foam material may be reused to produce more silicone foam following the removing step. It should also be noted that the present invention avoids the use of any solvents to remove the foaming agent and as such eliminates the possibility of the presence of possible contaminants in the silicone foam material. This is particularly important when the production of a medical prosthesis is being undertaken. The method also avoids the production of any waste materials and provides a foaming agent that is up to 100 percent reusable.

Of course, it should also be appreciated that no chemicals, gases or other potential hazardous agents are utilized to create the silicone foam product in the present method. Thus, the process is environmentally friendly. Further, the technique is applicable to all silicone foam compounds including condensation and platinum cure compounds.

Advantageously, the silicone foam material 10 produced provides consistent, repeatable results each time the silicone foam is made. The texture, hardness, softness and cellular size may be easily regulated by simply changing the quantity, size and shape of the mechanical foaming agent bodies used to produce the silicone foam product. An integral layered product may also be produced. This is particularly useful when the silicone foam is utilized in the production of prostheses. The prostheses may be molded with a solid skin layer, a cellular foam layer to provide the prosthesis with the proper, life-like feel and a porous backing layer for anchoring the prosthesis to the dermis of the patient. Since each of the various layers is made from the same silicone compound the layers avoid any tendency to separate and they age at the same rate.

The foregoing description of a preferred embodiment of the invention has been presented for purposes of illustration and description. It is not intended to be exhaustive or to limit the invention to the precise form disclosed. Obvious modifications or variations are possible in light of the above teachings. The embodiment was chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally and equitably entitled.

What is claimed:

1. A foam material, comprising:
a body of silicone having a cellular structure formed by a plurality of interconnected voids.

2. The foam material of claim 1 wherein said voids are interconnected by mechanically formed channels.

3. The foam material of claim 1 further including a density of between about 5 to about 10 lbs/ft³.

4. The foam material of claim 1, further including a compression deflection at 25 percent psi of about 0.5 to about 1.0 and at 50 percent psi of about 0.5 to about 3.0.

5. The foam material of claim 1, further including a specific gravity of about 0.1 to about 0.15.

6. The foam material of claim 3, further including a compression deflection at 25 percent psi of about 0.5 to about 1.0 and at 50 percent psi of about 0.5 to about 3.0.

7. The foam material of claim 6, further including a specific gravity of about 0.1 to about 0.15.

8. The foam material of claim 3, further including a specific gravity of about 0.1 to about 0.15.

9. The foam material of claim 4, further including a specific gravity of about 0.1 to about 0.15.

10. The foam material of claim 1, wherein said body comprises from about 25 to about 41% by volume silicone and from about 75 to about 59% by volume void space.

11. The foam material of claim 1, wherein each void of said plurality of interconnected voids has a volume of between about 0.06545 to about 268.0832 mm³.

12. The foam material of claim 11, further including a density of between about 5 to about 10 lbs/ft³.

13. The foam material of claim 1, wherein each of said plurality of interconnected voids has a volume of between about 65.45 to about 179.5948 mm³.

14. The foam material of claim 13, further including a density of between about 5 to about 10 lbs/ft³.

15. The foam material of claim 1 wherein said cellular structure comprises voids of consistent size.

16. A foam material, comprising:
a body of silicone having a plurality of voids, each void of said plurality of voids having a volume of between about 0.06545 to about 268.0832 mm³.

17. The foam material of claim 16 further including a density of between about 5 to about 10 lbs/ft³.

18. The foam material of claim 16, further including a compression deflection at 25 percent psi of about 0.5 to about 1.0 and at 50 percent psi of about 0.5 to about 3.0.

19. The foam material of claim 16, further including a specific gravity of about 0.1 to about 0.15.

20. The foam material of claim 17, further including a compression deflection at 25 percent psi of about 0.5 to about 1.0 and at 50 percent psi of about 0.5 to about 3.0.

21. The foam material of claim 20, further including a specific gravity of about 0.1 to about 0.15.

22. The foam material of claim 17, further including a specific gravity of about 0.1 to about 0.15.

23. The foam material of claim 18, further including a specific gravity of about 0.1 to about 0.15.

24. The foam material of claim 16, wherein said body comprises from about 25 to about 41% by volume silicone and from about 75 to about 59% by volume void space.

25. A foam material, comprising
a body of silicone having a plurality of voids, each void of said plurality of voids having a volume of between about 65.45 to about 179.5948 mm³.

26. The foam material of claim 25 further including a density of between about 5 to about 10 lbs/ft³.

27. The foam material of claim 25, further including a compression deflection at 25 percent psi of about 0.5 to about 1.0 and at 50 percent psi of about 0.5 to about 3.0.

28. The foam material of claim 25, further including a specific gravity of about 0.1 to about 0.15.

29. The foam material of claim 26, further including a compression deflection at 25 percent psi of about 0.5 to about 1.0 and at 50 percent psi of about 0.5 to about 3.0.

30. The foam material of claim 29, further including a specific gravity of about 0.1 to about 0.15.

31. The foam material of claim 26, further including a specific gravity of about 0.1 to about 0.15.

32. The foam material of claim 27, further including a specific gravity of about 0.1 to about 0.15.

33. The foam material of claim 25 wherein said body comprises from about 25 to about percent by volume silicone and from about 75 to about 59 percent by volume void space.
